(19) United States
(12) Patent Application Publication
(10) Pub. No.: US 2026/0351538 A1
(43) Pub. Date: Nov. 5, 2026

(54) APPARATUS AND METHOD FOR DETECTION OF HALOGENATED COMPOUNDS USING A HYBRID MASS SPECTROMETER

(71) Applicant: Kimia Analytics Inc., Richmond Hill (CA)

(72) Inventors: Sina ALAVI, North York (CA); Gholamreza JAVAHERY, Thornhill (CA)

(21) Appl. No.: 19/663,950

(22) Filed: Apr. 30, 2026

Related U.S. Application Data
(60) Provisional application No. 63/798,097, filed on May 1, 2025.

(51) Int. Cl. H01J 49/00; H01J 49/10; H01J 49/24

(52) U.S. Cl. CPC H01J 49/0031; H01J 49/0072; H01J 49/105; H01J 49/24

(57) ABSTRACT

The present invention provides a hybrid tandem inductively coupled plasma mass spectrometer (ICP-MS) system and method for the direct detection and quantification of atomic halogen anions, including fluoride (F⁻), chloride (Cl⁻), and optionally bromide and iodide. The system includes an inductively coupled plasma (ICP) ion source, a first mass analyzer for selecting background ions, a specialized sampling interface with an integrated reaction chamber operating at adjustable pressure, and a downstream collision/reaction cell. The invention addresses limitations in conventional ICP-MS systems where halogen-containing species are neutralized via recombination with abundant hydrogen cations, forming undetectable neutral hydrogen halides. The system overcomes this by generating or introducing background anions and directing them into a reaction environment where they undergo selective ion-molecule or ion-ion reactions to form detectable halogen anions.

### FIELD OF THE INVENTION

The present invention relates to an apparatus and method that enable the direct detection of halogens, with a particular focus on the quantification of fluoride (F⁻) and chloride (Cl⁻) at significant sensitivity levels.

### BACKGROUND OF THE INVENTION

Accurate and sensitive detection of halogen elements is essential in various fields, including environmental monitoring, food safety, materials science, and clinical diagnostics. Quantitative analysis of halogenated compounds is crucial due to their high electronegativity and widespread presence in various chemical and environmental applications, particularly in pharmaceuticals, environmental monitoring, and food safety. Among these, fluorinated and chlorinated compounds have attracted the most attention due to their increasing applications in major industrial sectors. Halogens, such as fluorine and chlorine, play significant roles, often as constituents of pollutants, additives, or biological molecules.

Inductively Coupled Plasma Mass Spectrometry (ICP-MS) is a widely employed analytical technique for elemental analysis due to its high sensitivity and broad elemental coverage. ICP-MS consists of two major components: the source, often referred to as the “plasma source”, and the mass spectrometer. The plasma source utilizes a high-temperature inductively coupled plasma (ICP) to generate high yields of atomic ions for elemental analysis. In ICP-MS, a sample is introduced into a high-temperature argon plasma, causing atomization and ionization of its constituent elements. Within this plasma, atomization and ionization processes occur, producing both atomic cations and anions. The resulting ions are then separated based on their mass-to-charge ratio and detected. However, conventional ICP-MS platforms face fundamental limitations in detecting halogens. One major challenge is that halogens, particularly fluorine and chlorine, are more effectively ionized in negative mode due to their high electronegativity. Yet, most ICP-MS systems are not designed to support the detection of negative ions. In positive mode, the direct detection of these elements with sufficient sensitivity is hindered by their high ionization energy-fluorine, for example, has an ionization energy of 17.4 eV which is higher than that of argon. Halogens possess high electron affinities, theoretically favoring the formation of negative ions through electron capture. The provided information confirms that elemental halogens do not exist freely in nature due to their high reactivity. In the context of an ICP, while initial ionization can lead to the formation of halogen anions, these species are prone to secondary reactions, particularly with the abundant hydrogen cations (H⁺) present in the plasma. These hydrogen ions originate from water molecules introduced with the sample matrix, air entrapment, or present as background contamination.

One method to enhance the detection of fluorinated and chlorinated compounds in positive ion mode is by introducing organic dopants to improve ionization efficiency. While these approaches have shown some success, achieving reliable and high-sensitivity detection of these elements remains a significant challenge. In the case of halogenated compounds, their high electron affinity suggests that the high-temperature plasma environment, combined with the abundance of free electrons, should facilitate the generation of atomic anions-specifically fluoride (F⁻) and chloride (Cl⁻)—through simple electron capture reactions:

Cl+e⁻→Cl⁻

F+e⁻→F⁻

It is also hypothesized that some anions are formed inside the supersonic expansion behind the sampling orifice or later stages of the mass spectrometer through electron capture. However, in practice, only a minimal amount of halogen atomic anions are detected by the mass spectrometer. This absence is attributed to secondary reactions, particularly with hydrogen cations (H⁺) that are readily produced from water molecules present in the sample. These reactions lead to the formation of neutral species, such as hydrofluoric acid (HF), via the following reaction:

F⁻+H⁺→HF

In general, atomic ions—both cations and anions—exhibit high reaction cross-sections with neutral species present in the plasma and within the upstream region of the mass spectrometer. ICP-MS platforms are specifically designed to minimize recombination reactions between these atomic ions and neutral species. However, in the case of cation-anion recombination or other ion-ion interactions, reaction cross-sections are even higher than for ion-neutral reactions. This makes it extremely challenging to prevent such recombination processes from occurring within the plasma source or in the high-pressure regions upstream of the mass spectrometer, where ion chemistry can readily proceed.

The dominant secondary reaction observed is the recombination of halogen anions (X⁻) with hydrogen cations (H⁺) to form neutral hydrogen halides (HX), such as hydrofluoric acid (HF) and hydrogen chloride (HCl). These neutral species cannot be detected by the mass spectrometer, leading to a significant reduction in the observed signal for atomic halogen anions. Consequently, conventional ICP-MS often suffers from low sensitivity or inability for the direct determination of these crucial analytes.

To overcome these limitations, researchers have explored various indirect methods for halogen determination using ICP-MS. These often involve derivatization steps to form more readily ionizable species or the detection of polyatomic ions containing halogens. However, these indirect methods can be complex, time-consuming, and may introduce potential sources of error.

The present invention addresses the need for a more direct and sensitive method for detecting and quantifying halogens. It recognizes the fundamental issue of recombination reactions within the plasma source and proposes a novel approach by decoupling the initial ionization process from a controlled ion-molecule or ion-ion reaction environment.

The present invention provides a new system and method to achieve this goal. The first two embodiments of the present invention integrate a reaction chamber within a specialized interface with adjustable pressure, in combination with a special reaction chamber, utilizing background ions and potentially in-situ formed hydrogen halides to generate the target anions. The third embodiment employs a standard interface but introduces the halogenated samples externally into a reaction cell to achieve halogen ionization through gas-phase reaction inside the collision cell. The fourth embodiment of the present invention includes an alternative ion source to generate background ions in addition to an external ICP source with a reaction chamber directly linked to a collision/reaction cell of the mass spectrometer. All embodiments leverage the principle of selectively guiding and reacting suitable background ions to ionize and enhance the signal of halogens, thus providing a significant advancement over traditional ICP-MS systems which are incapable of halogen detection with high sensitivity. This invention holds the potential to improve the sensitivity and accuracy of halogen analysis in various applications where these elements are of critical importance.

### SUMMARY OF THE INVENTION

The present disclosure is a system and a method for the direct detection and quantification of atomic halogen anions. The method comprises the steps of: (a) generating ions from a sample using an inductively coupled plasma mass spectrometer (ICP-MS) source; (b) selectively directing suitable background ions (with certain electron affinity levels) generated by the plasma source into a collision/reaction cell via a specialized reaction chamber within a special interface; (c) introducing hydrogen halides into the collision/reaction cell which are either formed inside the reaction chamber or from an external source; (d) reacting the selectively directed background ions with the hydrogen halides within the reaction cell to generate atomic halogen anions; and (e) analyzing the ions exiting the reaction cell using a mass analyzer to detect and quantify the atomic halogen anions. The atomic halogen anions detected and quantified are fluoride (F⁻) and chloride (Cl⁻).

This method can also be used for analysis of other halogens like Bromine or Iodine or other elements such as sulfur, phosphorus, selenium, or tellurium. Introducing nitrogen gas into the interface or reaction cell forms background anions selected from the group consisting of NO₂⁻ and NO₃⁻. The step of reacting the selectively directed background ions with hydrogen halides comprises reacting

$${NO}_{2}^{-} or {NO}_{3}^{-}$$

with hydrogen halides (HX, where X is a halogen) to produce atomic halogen anions (X⁻). Other background ions may be extracted from the species formed inside the plasma, sampling interface, or the reaction chamber (such as O⁻, OH⁻, O₂⁻, etc.) to react with the hydrogen halides and generate halogen anions, without introducing any gases. At the same time, other gases such as oxygen, carbon dioxide, carbon monoxide, nitrous oxide, and other suitable gases may be injected into the reaction chamber to form suitable background ions that can be used to re-ionize halogens inside the collision/reaction cell. In any case, the electron affinity of these background ions should be less than the electron affinity of the target halogens as described in Tables 1 and 2.

The present invention is also a hybrid tandem inductively coupled plasma mass spectrometer system for the direct detection of atomic halogen anions, comprising: (a) an inductively coupled plasma (ICP) source; (b) a mass analyzer for separating ions generated by the ICP source; (c) an interface fluidly connected to the mass analyzer with adjustable pressure, the interface including a collision/reaction cell configured to receive selected ions from the mass analyzer and a target sample; (d) a second mass analyzer downstream of the collision/reaction cell for analyzing product ions formed within the cell, wherein the target sample introduced into the cell facilitates the formation of atomic halogen anions through reactions with precursor ions.

A hybrid tandem inductively coupled plasma mass spectrometer for the direct detection of atomic halogen anions. (a) an inductively coupled plasma (ICP) source for generating ions; (b) a first mass filter (Q1) downstream of the ICP source for selectively passing background ions; (c) a reaction chamber located within an interface with adjustable pressure, wherein the selectively passed background ions react with hydrogen halides to form atomic halogen anions; and (d) a second mass analyzer downstream of the reaction chamber for detecting the atomic halogen anions.

The first mass filter (Q1) is configured to selectively pass NO₂⁻ ions into the collision/reaction cell or pass NO₃⁻ ions into the cell. Hydrogen halides (HX, where X is a halogen) are formed upstream of the collision/reaction cell due to recombination reactions inside the reaction chamber. The hydrogen halides are hydrofluoric acid (HF) and hydrochloric acid (HCl).

The method for the direct detection of atomic halogen anions using a hybrid tandem inductively coupled plasma mass spectrometer comprises of the following steps: (a) generating ions in an inductively coupled plasma (ICP) source; (b) selectively passing background ions generated by the ICP source using a first mass filter (Q1); (c) introducing the selectively passed background anions into a reaction chamber located within a high-pressure interface; (d) reacting the background ions with hydrogen halides present in the reaction chamber to form atomic halogen anions; and (e) detecting the formed atomic halogen anions using a second mass analyzer downstream of the reaction chamber.

Nitrogen gas is introduced into the reaction chamber to form the background ions, which are selected from the group consisting of NO₂⁻ and NO₃⁻. The second embodiment of the present invention comprises of the following elements: (a) an inductively coupled plasma (ICP) source for generating ions; b) a mass filter (Q1) downstream of the ICP source for selectively passing background ions formed within the interface; c) a collision/reaction cell located in a section of the mass spectrometer downstream of the interface, wherein the selectively passed background ions react with halogen-containing compounds introduced externally into the collision/reaction cell; and d) a second mass analyzer downstream of the collision/reaction cell for detecting the atomic halogen anions formed within the reaction cell.

The background ions formed within the interface are selected from the group consisting of, but not limited to, O⁻, OH⁻, O₂⁻, and NO₂⁻. The mass filter (Q1) is configured to selectively pass O⁻, OH⁻, O₂⁻, or NO₂⁻ ions into the collision/reaction cell. The halogen-containing compounds of interest are introduced externally into the collision/reaction cell. These compounds can be hydrogen halides formed inside an external ICP source equipped with a reaction chamber selected from the group consisting of HF and HCl. The halogen-containing compounds introduced externally into the collision/reaction cell are halogen compounds that react with the selected background ion to form F⁻ or Cl⁻.

Another embodiment of the same method for the detection of atomic halogen anions is by using a tandem inductively coupled plasma mass spectrometer with a standard interface and external reagent or sample introduction. This method comprises the steps of: (a) generating ions in an inductively coupled plasma (ICP) source; (b) forming background ions within the standard interface; (c) selectively passing the background ions using a first mass filter (Q1); (d) introducing halogen-containing compounds of interest externally into a collision/reaction cell located at some stage of the spectrometer downstream of the first mass filter; (e) reacting the selectively passed background ions with the externally introduced halogen-containing compounds within the collision/reaction cell to form atomic halogen anions; and (f) detecting the formed atomic halogen anions using a second mass analyzer downstream of the collision/reaction cell.

The background anions formed within the standard interface are selected from the group consisting of but not limited to O⁻, OH⁻, O₂⁻, and NO₂⁻. The halogen-containing compounds introduced externally into the collision/reaction cell are hydrogen halides selected from the group consisting of HF and HCl.

The present invention offers a significant improvement in the direct detection and quantification of atomic halogen anions by:
Minimizing sample loss due to recombination: By employing a dedicated reaction chamber downstream of the initial plasma ionization, the invention mitigates the loss of halogen anions due to recombination with hydrogen ions in the primary plasma environment. Using this reaction chamber, These hydrogen halides can be efficiently formed and contained within the reaction chamber, which can then be transferred to a dedicated collision/reaction cell to be recognized but suitable background ions in a controlled environment.
Enhanced Sensitivity: Through controlled ion-molecule or ion-ion reactions with specifically chosen background ions and halogen-containing compounds, the yield of atomic halogen anions is significantly enhanced, leading to improved detection sensitivity.
Versatility through multiple embodiments: The four described embodiments offer flexibility in implementation, utilizing either a specialized interface with adjustable pressure with in-situ reagent formation or a standard interface with external sample/reagent introduction.
Specific Ion Chemistry: The invention leverages specific ion chemistry principles, such as the exothermic nature of reactions based on electron affinities, to drive the efficient formation of the target analytes.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A shows the first embodiment of the present invention;

FIG. 1B shows a schematics of ion path and parameters;

FIG. 2 shows the first embodiment—Hybrid tandem ICP mass spectrometer with reaction chamber in the interface;

FIG. 3 Shows formation of background ions when the reaction chamber has been pressurized by nitrogen;

FIG. 4 shows the second embodiment—Hybrid tandem ICP mass spectrometer with reaction chamber in the interface and transfer line between reaction chamber and collision/reaction cell;

FIG. 5 shows the third embodiment of the present invention;

FIG. 6 shows the third embodiment—standard interface with collision/reaction cell and sample introduction line to the cell;

FIG. 7 shows embodiment 3—Formation of Cl⁻ via exothermic reaction of NO₂⁻ with neutral HCL;

FIG. 8 shows embodiment 3—No significant Cl⁻ is formed due to endothermic reaction of NO₃⁻ with neutral HCL;

FIG. 9 shows formation of background ions;

FIG. 10 shows formation of Cl− from reaction of O⁻ with HCl;

FIG. 11 shows formation of F⁻ from reaction of O⁻ with a fluorinated compound, and

FIG. 12 shows the fourth embodiment—Mass spectrometer with alternative ion source and an external ICP source connected through transfer line.

### DETAILED DESCRIPTION OF THE INVENTION

The core concept of this invention utilizes a new interface design equipped with a reaction chamber in combination with a tandem mass spectrometer with a collision/reaction cell implemented at any stage of the spectrometer. An ionization source can be used to form a group of ionic and neutral species which can then be sampled into the reaction chamber within the sampling interface of the mass spectrometer. In this case, using a high temperature source like the ICP can be beneficial as it can desolvate, evaporate, atomize and ionize the sample while generating a high abundance of ions that can be used downstream of the mass spectrometer for gas phase reaction. The high temperature and energy density can be beneficial to minimize matrix effects, matrix dependence, and signal suppression due to various samples. These adverse effects are common with other ionization sources like ESI, APCI, APPI, Electron Impact, glow discharge, corona discharge, cold plasma sources and other types of sources that are commonly used in molecular mass spectrometry. By using a higher temperature ionization sources we can create a robust detection method that is relatively independent from the composition of the sample four distinct embodiments are described here.

The high electron affinity of halogen atoms suggests that the high-temperature plasma environment of an ICP source, coupled with the abundance of free electrons, should readily facilitate the generation of atomic halogen anions (F⁻ and Cl⁻) through electron capture reactions from halogenated compounds present in a sample. Also it is suggested by some researchers that anions may form behind the sampling orifice of a typical ICP-MS system or inside other downstream sections of the mass spectrometer due to electron capture or other forms of reactions with the halogen atoms. However, in practice, the concentration of these atomic anions observed directly from the plasma is often low due to rapid recombination reactions with hydrogen (H⁺) or other positive ions, which are abundantly formed from water molecules or other atoms present in the sample matrix. This recombination leads to the formation of neutral hydrogen halides (for example HF, HCl), which are not detectable by standard mass spectrometry. Furthermore, these neutral species cannot be focused, transmitted, or manipulated by the electrical components of the mass spectrometer (such as ion lenses, ion guides, ion deflectors, etc.) due to not having any charge. Therefore, they cannot be transferred to the other sections of the mass spectrometer where there may be a chance to re-ionize them for detection. As a result, these species are simply lost and vented by the vacuum pumps together with the other background gases.

The present invention overcomes these limitations by combining a new reaction chamber within a new sampling interface with a collision/reaction cell in a tandem mass spectrometer in which the neutral halogen species can be captured and directed to the collision/reaction cell in which they can be re-ionized through ion-molecule or ion-ion reactions.

The present invention relates to an apparatus and method that enable the direct detection of atomic halogen anions, with a particular focus on the quantification of fluoride (F⁻) and chloride (Cl⁻) at significant sensitivity levels. This apparatus and method can also be used for sensitive detection of other elements such as bromine, iodine, phosphorus, sulfur, selenium or tellurium which suffer from low sensitivity and analytical challenges in traditional ICP-MS. The invention comprises a tandem mass spectrometer equipped with a specialized interface with adjustable pressure that facilitates ion-molecule and ion-ion reactions with high efficiency. A high temperature ionization source with high power density such as ICP can be used to desolvate, vaporize, atomize and ionize the sample species. The role of the high temperature source would be to transform the sample into gas phase to be handled by the mass spectrometer. Ideally the ionization source should be able to work with relative independence from the composition and matrix of the sample. In this way, the detection method will be matrix independent. That is why ICP can be a suitable candidate for this application. The ionization source may also generate some background ions which can later be used in reactions to ionizes the target elements.

As the products of the high temperature ionization source pass into the sampling interface, several new background ions may form inside the reaction chamber, in addition to formation of hydrogen halides or other halogenated molecules. Certain compounds can be co-injected into the ionization source to generate ions that can also participate in reactions inside the reaction chamber or collision/reaction cell. These compounds can include elements such as sodium, aluminum, magnesium, barium, cerium, lanthanide-group elements, yttrium, strontium, scandium, gallium, titanium, and so on, which can form larger molecules containing the halogen atoms inside the reaction chamber. In combination with adjusting the pressure of the reaction chamber, several different gases can also be introduced into the reaction chamber from a separate inlet to control the reactions inside the chamber and obtain the desirable background ions or halogenated species.

Since the halogenated species such as HF or HCL will be neutral, they cannot be transferred to the mass analyzer or ion detector using conventional electrical components such as ion lenses, ion guides, ion deflectors, and so on. However, using a transfer line directly connected to the reaction chamber, they can be sampled and transferred to a collision/reaction cell. The pressure of the reaction chamber will be typically higher (e.g., in the range of 0.1 Torr to atmospheric pressures or higher) than the pressure of the collision/reaction cell which is typically maintained at micro Torr to 1-100 milliTorr pressure levels. Therefore, by adjusting the pressure of the reaction chamber and an adjustable flow valve on the transfer line, the flow of neutral halogenated species such HF and HCL into the collision/reaction cell can be precisely adjusted.

At the same time, suitable background ions generated by the plasma source or inside the reaction chamber, can be selected based on their electron affinity and guided to the dedicated collision/reaction cell. Between the reaction chamber and the collision/reaction cell, various components such as lenses, ion guides, or ion deflectors can be used to focus and transfer the background ions, while various types of mass analyzers such as quadrupoles or other types of mass filters can be used to select the desirable background ion and prevent the rest from entering the collision/reaction cell. Within this collision/reaction cell, the neutral halogenated compounds coming from the reaction chamber through the transfer line and the background ions can react to produce high yields of F⁻ and Cl⁻. The formation of atomic halogen anions occurs within the collision/reaction cell via specific ion chemistry mechanisms. This is an important aspect and novelty of the current invention.

Some examples of possible reaction mechanisms for ionizing atomic anion halogens are provided below. In this case, the background ions having electron affinities lower than the target halogen will react and release atomic halogen anions. However, if the electron affinity is higher than that of the target halogen (for example in the case of NO₃⁻), the reaction will not proceed This provides an effective way of re-ionizing the neutralized halogen species within a dedicated collision/reaction chamber in which the reactions can be carefully engineered by controlling the incoming reactants and the chemical environment inside the cell. Other collision/reaction gases may also be introduced from external sources to the cell to enhance the production of atomic halogens or act as catalyzers.

$${O}_{2}^{-} + HF \to {F}^{-} + {HO}_{2}$$

$${O}_{2}^{-} + HCl \to {Cl}^{-} + {HO}_{2}$$

$${NO}_{2}^{-} + HF \to {F}^{-} + {HNO}_{2}$$

$${NO}_{2}^{-} + HCl \to {Cl}^{-} + {HNO}_{2}$$

$${O}_{3}^{-} + HF \to {F}^{-} + Products$$

$${CO}_{3}^{-} + HF \to {F}^{-} + Products$$

$$OH - {NO}_{2}^{-} + HF \to {F}^{-} + Products$$

$${O}^{-} + HF \to {F}^{-} + OH$$

$${O}^{-} + HCl \to {Cl}^{-} + OH$$

$${OH}^{-} + HF \to {F}^{-} + {H}_{2} O$$

$${OH}^{-} + HCl \to {Cl}^{-} + {H}_{2} O$$

$${NO}_{3}^{-} + HF \to No Reaction$$

$${NO}_{3}^{-} + HCl \to No Reaction$$

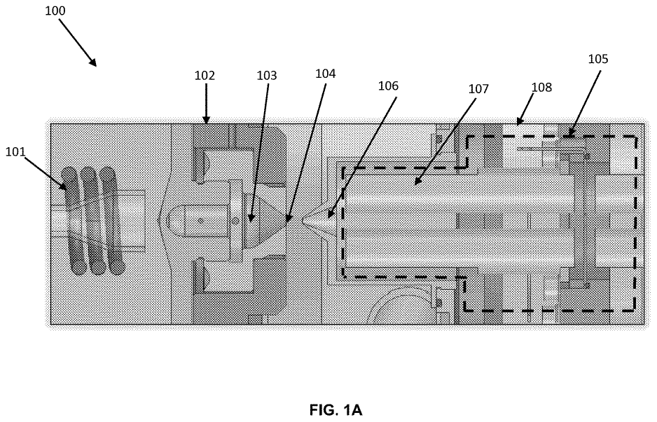

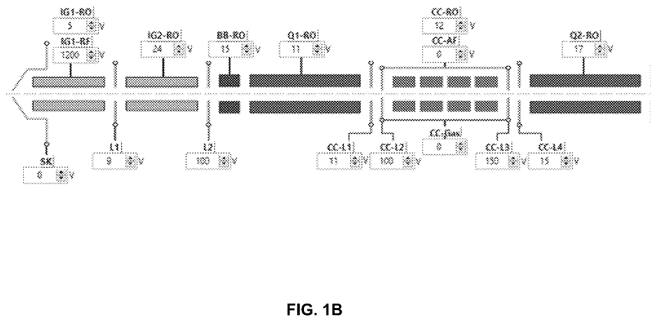

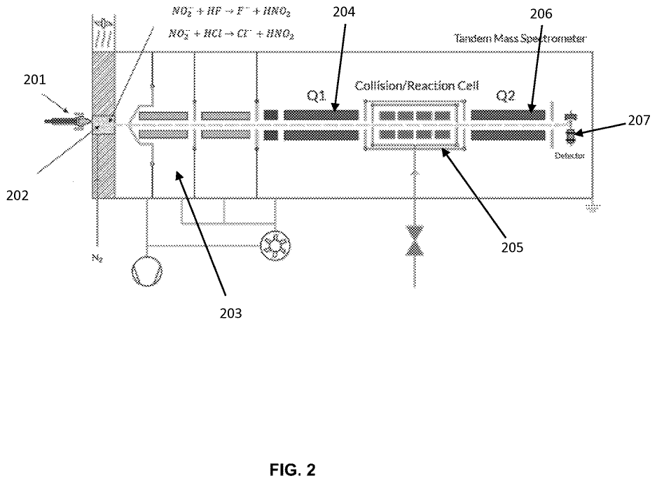

FIGS. 1A, 1B and 2 illustrates a first embodiment of the present invention, configured as a hybrid tandem inductively coupled plasma (ICP) mass spectrometer.

FIG. 1A illustrates a cross-sectional view of an interface region (100) of a hybrid tandem inductively coupled plasma (ICP) mass spectrometer. The system includes a plasma source (101) configured to generate ions from a sample. The ions are extracted through an interface region (102) and directed along an ion path toward downstream components. The interface region (102) includes a reaction chamber (103) positioned downstream of the plasma source (101). The reaction chamber (103) is configured to operate at an elevated pressure relative to downstream regions and provides a controlled environment for ion-molecule reactions and recombination processes. Within the reaction chamber (103), neutral halogen-containing species, including hydrogen halides such as HF and HCl, may be formed. An extraction orifice (104) is provided at an outlet of the reaction chamber (103) to facilitate transfer of species from the reaction chamber (103) into a lower-pressure region. Downstream of the reaction chamber (103), an ion optics assembly (105) is provided, including one or more electrostatic lenses and apertures configured to focus and guide ions along the ion path. A conical ion focusing element (106) may be positioned adjacent the extraction orifice (104) to improve ion transmission efficiency. Further downstream, a mass analyzer (107), such as a quadrupole mass filter including a plurality of rod electrodes, is configured to selectively transmit ions based on mass-to-charge ratio. A housing or vacuum chamber (108) encloses the ion optics assembly (105) and the mass analyzer (107) and maintains a reduced-pressure environment relative to the reaction chamber (103). In operation, ions generated in the plasma source (101) pass through the interface region (102) into the reaction chamber (103), where chemical reactions may occur. Neutral species formed within the reaction chamber (103) are transferred through the extraction orifice (104), while ions are guided by the ion optics assembly (105) toward the mass analyzer (107) for subsequent analysis.

FIG. 1B illustrates a schematic representation of an ion optics and mass filtering configuration of a tandem mass spectrometer, showing electrical biasing and operating parameters applied to various components along an ion transmission path. As shown, ions travel along a central ion path (indicated by the dashed line) from left to right through a sequence of ion guides, lenses, and mass filtering elements. An upstream ion guide (IG1) is configured with both RF and DC potentials (IG1-RF, IG1-RO), enabling confinement and transmission of ions. A second ion guide (IG2) downstream of IG1 further conditions the ion beam using an applied DC bias (IG2-RO). Intermediate lens elements (L1, L2) are provided to focus and control ion energy and trajectory. A bias element (BB) is positioned between the ion guides and a first quadrupole mass filter (Q1), where the bias voltage (BB-RO) assists in ion energy alignment prior to mass selection. The first quadrupole mass filter (Q1) operates under a defined DC offset (Q1-RO) to selectively transmit ions based on mass-to-charge ratio. Downstream of Q1, a collision/reaction cell (CC) is provided, including multiple electrodes (CC-L1, CC-L2, CC-L3, CC-L4) configured with respective voltages to control ion transmission and reaction conditions. The collision/reaction cell is supplied with a collision or reaction gas (CC-Gas), and parameters such as axial field (CC-AF) and DC bias (CC-RO) are adjusted to promote ion-molecule reactions or collisional cooling. Following the collision/reaction cell, ions are transmitted to a second quadrupole mass filter (Q2), which is operated with a defined DC offset (Q2-RO) for further mass selection prior to detection. Additional elements, such as a skimmer (SK), are positioned upstream to assist in extracting ions from a higher-pressure region into the ion optics assembly. The illustrated voltage values adjacent to each component represent example operating conditions and may be adjusted to optimize ion transmission efficiency, reaction kinetics, and mass filtering performance.

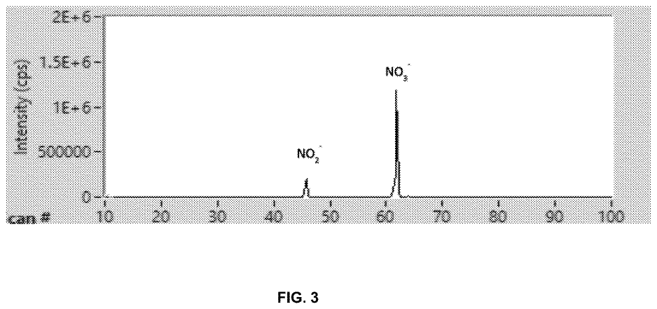

FIG. 2 illustrates a system comprising a plasma source (201), an interface region with a reaction chamber (202), an ion optics assembly (203), a first quadrupole mass filter Q1 (204), a collision/reaction cell (205), a second quadrupole mass filter Q2 (206), and a detector (207). In this embodiment, nitrogen (N₂) is introduced into the reaction chamber (202), where it reacts to generate background anions such as NO₂⁻ and NO₃⁻. Subsequently, hydrogen chloride (HCl) and hydrogen fluoride (HF) are introduced and react with these background ions to produce halide ions, including Cl⁻ and F⁻. Alternatively, additional compounds or elements may be co-injected with a halogen-containing sample into the plasma source (201). These species pass through the interface into the reaction chamber (202), where they react with fluorine or chlorine to form cluster ions or larger polyatomic molecular ions containing halogens. These resulting cluster or molecular ions can then be selectively transmitted through Q1 (204) and Q2 (206) and detected at the detector (207) for sensitive and selective halogen analysis. In the presence of other unwanted species inside the reaction chamber, hydrogen halides (neutral) may be formed from recombination of halogen anions with hydrogen and other species inside the reaction chamber. This is typically a dominant process which leads to loss of halogen signal and low sensitivity. Two of the most abundant background anions observed due to nitrogen introduction are shown in FIG. 3. NO₂⁻ and NO₃⁻ are the main anions observed when nitrogen is injected into the reaction chamber. Based on tables 1 and 2, it is expected that the reaction of NO₂⁻ with HCl or HF proceed with high efficiency to produce Cl⁻ or F⁻. This is due to the fact that the electron affinity of the NO₂ (2.27 eV) is lower than that of the HCl or HF therefore reaction is considered to be exothermic. NO₃, on the other hand, has higher electron affinity than that of HCl and HF therefore reaction is endothermic and should not proceed to form Cl⁻ or F⁻. By injecting various suitable compounds or gases into the cavity, background anions can be formed that can react with HCl or HF to produce Cl⁻ and F⁻. Example of these reactions are shown above.

TABLE 1
Electron affinity of potential background molecules

| Compound | Electron Affinity (eV) |
|---|---|
| O₂ | 0.451 |
| NO₂ | 2.27 |
| NO₃ | 4.1 |
| CO3 | 2.69 |
| OH—N₂O | 2.12 eV |
| OH | 1.8 eV |
| O | 1.46 eV |
| FH₂ | 3.66 eV |

TABLE 2
Electron affinity of halogen atoms

| Halogen | Electron Affinity (eV) |
|---|---|
| Fluorine | 3.40 |
| Chlorine | 3.61 |
| Bromine | 3.36 |
| Iodine | 3.06 |

Embodiment 1 is a Hybrid Tandem ICP Mass Spectrometer with Reaction Chamber in the Interface. This embodiment features a hybrid tandem ICP-MS system where a reaction chamber is incorporated within a specialized interface, with adjustable pressure, connecting the ICP source to the mass analyzer. The key steps and components of this embodiment are: (1) Ion Generation: The sample, potentially containing halogenated compounds, is introduced into the ICP source, where it is desolvated, evaporated, atomized and ionized, generating a plasma containing various ions, including precursor ions of halogens. (2) Selective direction of background Ions: Background ions generated by the plasma source are directed into the dedicated collision/reaction cell through a specialized reaction chamber design within the interface. This selective direction is crucial for isolating specific reactant ions for subsequent reactions. (3) Formation of Halogen Hydrates Upstream: Halogen hydrates (though not explicitly detailed in their formation mechanism, they are implied as precursors) are formed upstream within the ICP-MS system or inside the reaction chamber. (4) Controlled Reactions in the Collision/Reaction Cell: Within the collision/reaction cell, the selectively directed background ions undergo controlled reactions with the halogen hydrates. These reactions are designed to yield high quantities of atomic halogen anions (F⁻ and Cl⁻). The specific nature of these reactions is not explicitly defined but is implied to be more favorable for atomic anion formation than the direct plasma environment. (5) Mass Analysis and Quantification: Ions exiting the collision/reaction cell, including the generated atomic halogen anions, are then analyzed by a downstream mass analyzer for detection and quantification.

Embodiment 1 is a Hybrid Tandem ICP Mass Spectrometer with Reaction Chamber in the Interface. This embodiment features a hybrid tandem ICP-MS system where a reaction chamber (202) is incorporated within a specialized interface, with adjustable pressure, connecting the ICP source (201) to the mass analyzer system, including a first mass filter Q1 (204), a collision/reaction cell (205), a second mass filter Q2 (206), and a detector (207). The key steps and components of this embodiment are: (1) Ion Generation: The sample, potentially containing halogenated compounds, is introduced into the ICP source (201), where it is desolvated, evaporated, atomized, and ionized, generating a plasma containing various ions, including precursor ions of halogens. (2) Selective Direction of Background Ions: Background ions generated by the plasma source (201) are directed into the system through the reaction chamber (202) and ion optics assembly (203), and selectively transmitted via the first mass filter Q1 (204) into the collision/reaction cell (205). This selective transmission is crucial for isolating specific reactant ions for subsequent reactions. (3) Formation of Halogen Species Upstream: Halogen-containing species (including neutral or weakly bound halogen compounds) are formed upstream within the ICP source (201) and/or within the reaction chamber (202), where controlled pressure and gas composition facilitate their generation. (4) Controlled Reactions in the Collision/Reaction Cell: Within the collision/reaction cell (205), the selectively transmitted background ions undergo controlled reactions with the halogen-containing species to yield high quantities of atomic halogen anions (F⁻ and Cl⁻). These reactions are more favorable than those occurring directly in the plasma environment. (5) Mass Analysis and Quantification: Ions exiting the collision/reaction cell (205), including the generated atomic halogen anions, are then filtered by the second mass filter Q2 (206) and subsequently detected by the detector (207) for analysis and quantification.

A specific implementation within this embodiment involves the introduction of nitrogen gas into the reaction chamber (202). This leads to the formation of background anions such as NO₂⁻ and NO₃⁻ within the reaction chamber (202). These background anions are then transmitted through the ion optics assembly (203) and into the collision/reaction cell (205), optionally after selection by the first mass filter Q1 (204). Within the collision/reaction cell (205), the background anions react with hydrogen halides (HCl and HF) to produce the desired Cl⁻ and F⁻ ions. The electron affinity of NO₂⁻ (approximately 2.27 eV) is lower than that of HCl and HF, making the reaction exothermic and more likely to proceed efficiently toward formation of Cl⁻ and F⁻. Conversely, NO₃⁻ has a higher electron affinity, making the reaction endothermic and less likely to produce the halogen anions under the same conditions. The resulting ions are subsequently transmitted through the second mass filter Q2 (206) and detected by the detector (207).

A specific implementation within this embodiment involves introduction of nitrogen gas into the reaction chamber (202). This results in formation of background anions, including NO₂⁻ and NO₃⁻. The background anions are transmitted through the ion optics assembly (203) and may be selected by the first mass filter Q1 (204) and directed into the collision/reaction cell (205). Within the collision/reaction cell (205), the background anions react with hydrogen halides, including HCl and HF, to produce halogen anions Cl⁻ and F⁻. The reaction of NO₂⁻ is favorable due to its lower electron affinity (approximately 2.27 eV) relative to HCl and HF, resulting in an exothermic reaction that proceeds efficiently to form Cl⁻ and F⁻. In contrast, NO₃⁻ has a higher electron affinity, and its reaction with HCl or HF is endothermic and therefore less likely to produce halogen anions under the same conditions. The resulting halogen anions are subsequently transmitted through the second mass filter Q2 (206) and detected by the detector (207).

FIG. 4 illustrates a second embodiment of the present invention, configured as a hybrid tandem inductively coupled plasma (ICP) mass spectrometer. The system includes a plasma source (401), an interface region incorporating a reaction chamber (402), a transfer line or transfer tube (403), a first quadrupole mass filter Q1 (404), a dedicated collision/reaction cell (405), a second quadrupole mass filter Q2 (406), and a detector (407). A gas delivery system (408, 409) is fluidically coupled to the reaction chamber (402) and/or the dedicated collision/reaction cell (405). In this embodiment, nitrogen (N₂) is introduced into the reaction chamber (402), forming background anions such as NO₂ and NO₃. Simultaneously, halogen anions (e.g., F⁻ and Cl⁻) generated in the plasma source (401) recombine with hydrogen ions (H⁺) within the reaction chamber (402) to form neutral hydrogen halides, including HF and HCl. In conventional ICP-MS systems, such neutral species would typically be lost. However, in the present invention, these neutral species are extracted from the reaction chamber (402) through the transfer tube (403), which is fluidically connected to the dedicated collision/reaction cell (405). The reaction chamber (402) thereby functions as a vessel for forming and containing halogenated species at high abundance, which are subsequently transferred to the collision/reaction cell (405) for re-ionization and analysis. For example, by selecting a suitable background ion (e.g., NO₂) using the first quadrupole mass filter Q1 (404), halide ions such as F⁻ or Cl⁻ can be formed within the collision/reaction cell (405). In one implementation, NO₂⁻ is selected and directed into the collision/reaction cell (405), while neutral HCl formed in the reaction chamber (402) is simultaneously introduced via the transfer tube (403). The resulting reaction proceeds efficiently:

$${NO}_{2}^{-} + HCl \to {Cl}^{-} + {HNO}_{2}$$

The formation of Cl⁻ and its associated isotopes, subsequently analyzed by Q2 (406) and detected at the detector (407), confirms that this exothermic reaction proceeds with high efficiency, enabling sensitive detection of the halogen of interest. In contrast, the reaction between NO₃⁻ and neutral HCl is endothermic and is not expected to proceed:

$${NO}_{3}^{-} + HCl \to No Reaction$$

Nevertheless, NO₃ ions may be fragmented within the collision/reaction cell (405) by adjusting operational parameters such as cell pressure, introduction of suitable collision gases via the gas delivery system (408, 409), and electrical settings (e.g., acceleration voltage and rod offset relative to Q1 (404)). This fragmentation can generate NO₂ in situ, which can then participate in subsequent reactions to form Cl⁻.

Embodiment 2 is a hybrid tandem inductively coupled plasma (ICP) mass spectrometer including a plasma source (201), an interface incorporating a reaction chamber (202), an ion optics assembly (203), a first mass filter Q1 (204), a collision/reaction cell (205), a second mass filter Q2 (206), and a detector (207), and provides a mechanism for generation of atomic halogen anions. (1) Formation of Background Anions: Nitrogen gas is introduced into the reaction chamber (202) within the interface to generate background anions, including NO₂⁻ and NO₃⁻. (2) Formation and Presence of Hydrogen Halides: Hydrogen halides (HF and HCl) are formed within the plasma source (201) and/or the reaction chamber (202), for example by recombination of halogen ions (F⁻, Cl⁻) with hydrogen ions (H⁺), and are present as neutral species within the reaction chamber (202). (3) Selective Background Ion Selection: A selected background ion is transmitted through the ion optics assembly (203) and is mass-selected by the first mass filter Q1 (204) and directed into the collision/reaction cell (205). (4) Reaction with Hydrogen Halides: Within the collision/reaction cell (205), the selected background ion (e.g., NO₂⁻) reacts with the hydrogen halides (HF or HCl) to form atomic halogen anions (F⁻ or Cl⁻). The reaction is exothermic due to the lower electron affinity of NO₂⁻ relative to the hydrogen halides, thereby promoting efficient formation of halogen anions. (5) Second Mass Analysis: The resulting halogen anions are transmitted through the second mass filter Q2 (206) and detected by the detector (207) for analysis and quantification.

In this embodiment, the combination of the plasma source (201) and the reaction chamber (202) acts as a source of hydrogen halides (HCl or HF), which are neutral species and are not directly detectable by the mass spectrometer. By extracting or conveying these compounds from the reaction chamber (202) into the collision/reaction cell (205), and reacting them with a suitable reactant ion selected by the first mass filter Q1 (204), halogen anions Cl⁻ or F⁻ are generated in a controlled environment. The resulting ions are subsequently transmitted through the second mass filter Q2 (206) and detected by the detector (207). This controlled conversion of neutral species into detectable halogen anions represents an aspect of the present invention not present in conventional ICP-MS systems.

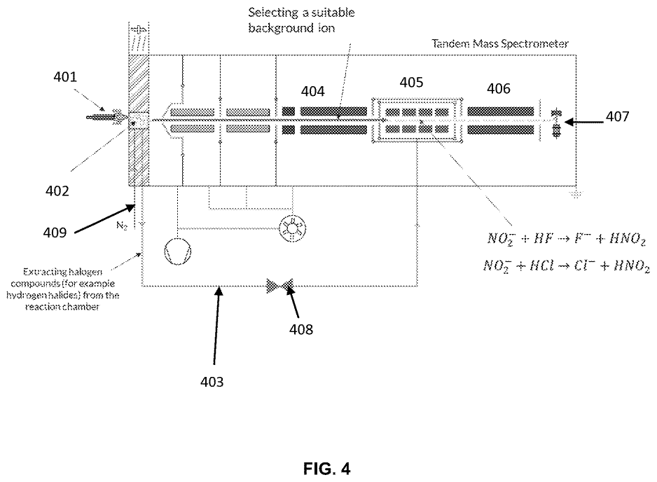

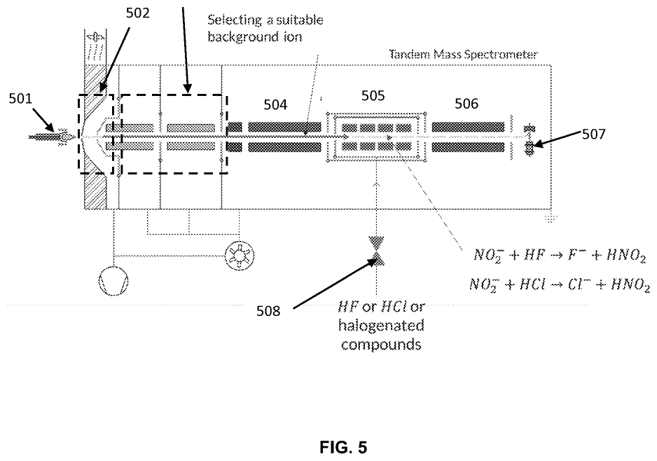

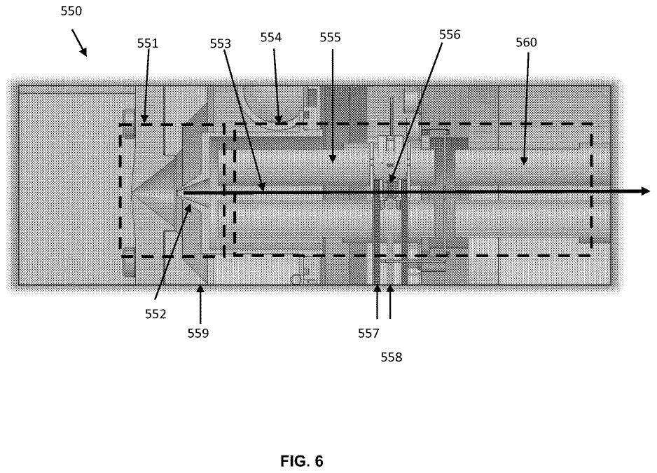

FIGS. 5 and 6 illustrate a third embodiment of the present invention, configured as a hybrid tandem inductively coupled plasma (ICP) mass spectrometer employing a conventional interface and a collision/reaction cell. The system in FIG. 5 includes a plasma source (501), an interface region (502), an ion optics assembly (503), a first quadrupole mass filter Q1 (504), a collision/reaction cell (505), a second quadrupole mass filter Q2 (506), and a detector (507). A gas introduction system (508) is fluidically connected to the collision/reaction cell (505). In this embodiment, background anions such as O⁻, OH⁻, O₂⁻, or NO₂⁻ are generated within the interface region (502). A suitable background ion (e.g., O⁻) is selectively transmitted using the first quadrupole mass filter Q1 (504). Hydrogen halides or halogen-containing compounds, such as HF or HCl, are then introduced externally into the collision/reaction cell (505) via the gas introduction system (508). Within the collision/reaction cell (505), the selected background ion reacts with the introduced species to form halide ions, including F⁻ or Cl⁻. The resulting halide ions are subsequently transmitted through the second quadrupole mass filter Q2 (506) and detected at the detector (507), enabling selective and sensitive detection of halogen elements.

FIG. 6 illustrates a cross-sectional view of an interface and ion transmission region (550) of a tandem mass spectrometer. A sampling interface (551) is positioned at an upstream end and includes a conical extraction element (552) configured to transfer ions from a higher-pressure region into a reduced-pressure region. Ions are directed along an ion path (553) extending through the system. Downstream of the sampling interface (551), an ion optics assembly (554) is provided, including an ion guide (555) comprising a plurality of rods configured to confine and transport ions along the ion path (553). A reaction or interaction region (556) is defined within or adjacent to the ion guide (555). A gas introduction assembly (557) is fluidically coupled to the reaction region (556) and includes an inlet conduit (558) configured to introduce a reaction or collision gas into the ion path (553). The gas is introduced into the ion guide (555), allowing ions traveling along the ion path (553) to interact with the introduced gas. A housing (559) surrounds the ion optics assembly (554) and maintains structural alignment while preserving a reduced-pressure environment. Downstream of the reaction region (556), additional ion guide or mass filtering components (560) are provided to direct ions toward a detector (not shown).

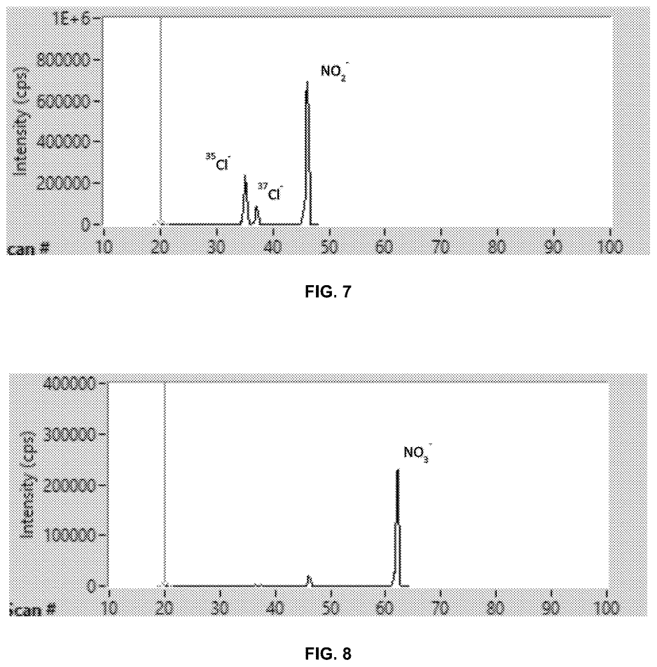

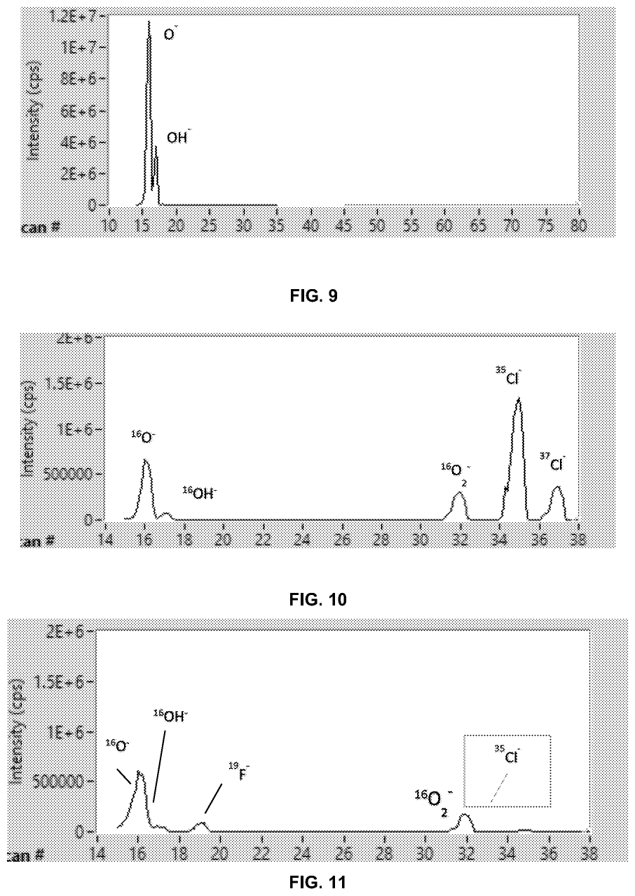

For the standard ICP-MS interface (i.e., without reaction chamber), some of the predominant background ions are shown in the FIGS. 7 and 8 (such as O⁻ and OH⁻). The reaction of both ions with HCl and HF may proceed readily through dissociation charge transfer reaction to create Cl⁻ and F⁻ to a significant level. Examples of Cl⁻ and F⁻ formation are shown in FIGS. 9, 10 and 11, respectively.

O⁻+HF→F⁻+OH

O⁻+HCl→Cl⁻+OH

OH⁻+HF→F⁻+H₂O

OH⁻+HCl→Cl⁻+H₂O

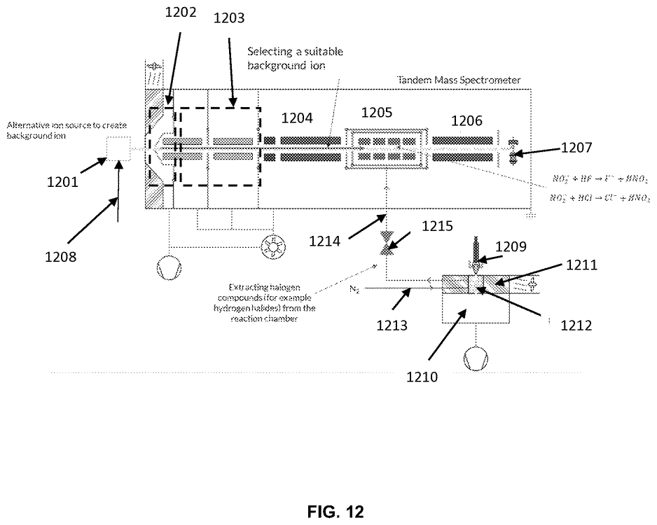

FIG. 12 illustrates a fourth embodiment of the present invention, configured as a tandem mass spectrometer incorporating a primary ionization source (1201) capable of generating background ions using buffer gases such as nitrogen, oxygen, argon, helium, carbon dioxide, or other suitable gases. The system further includes an interface region (1202), an ion optics assembly (1203), a first mass analyzer or mass filter (e.g., quadrupole) Q1 (1204), a collision/reaction cell (1205), a second mass analyzer Q2 (1206), and a detector (1207). A gas supply system (1208) is operatively coupled to the ionization source (1201) and/or the collision/reaction cell (1205).

The ionization source (1201) may comprise any suitable ionization mechanism capable of ionizing gases and reagents of interest, including but not limited to a cold plasma source, corona discharge source, glow discharge source, electron impact ionizer, atmospheric pressure chemical ionization (APCI), atmospheric pressure photoionization (APPI), or electrospray ionization (ESI). Background ions generated by the ionization source (1201) are selectively transmitted through Q1 (1204) and introduced into the collision/reaction cell (1205).

The embodiment further includes an additional high-temperature ionization source (1209), such as an inductively coupled plasma (ICP) source, positioned external to the tandem mass spectrometer. The ICP source (1209) is coupled to a vacuum chamber (1210) having a sampling interface (1211). The sampling interface (1211) includes a reaction chamber (1212) with adjustable pressure.

In operation, samples containing halogen compounds (e.g., fluorine- or chlorine-containing species) are introduced into the ICP source (1209), where they are desolvated, vaporized, atomized, and ionized. The resulting species pass through the sampling interface (1211) into the reaction chamber (1212), where they may react with each other or with gases or reagents introduced via a secondary inlet (1213). These reactions are configured to generate neutral halogen-containing compounds, such as hydrogen halides (e.g., HF, HCl), at high abundance.

The neutral halogen compounds are then transferred from the reaction chamber (1212) to the collision/reaction cell (1205) via a transfer line (1214). The flow rate through the transfer line (1214) may be controlled by adjusting the pressure within the reaction chamber (1212) and/or by a valve (1215) disposed along the transfer line.

Within the collision/reaction cell (1205), the neutral halogen compounds react with the selected background ions to form halogen anions (e.g., F⁻, Cl⁻). These anions are subsequently transmitted through Q2 (1206) and detected by the detector (1207), enabling selective and sensitive halogen analysis.

Embodiments herein will hereinafter be described in conjunction with the appended drawings provided to illustrate and not to limit the scope of the claims, wherein like designations denote like elements, and in which: The present invention provides an apparatus and method for the direct detection and quantification of atomic halogen anions, particularly fluoride (F⁻) and chloride (Cl⁻), with enhanced sensitivity. This invention addresses the limitations of conventional inductively coupled plasma mass spectrometry (ICP-MS) and other mass spectrometer types in directly detecting atomic halogen anions, which are often present in minimal amounts due to their high ionization potentials in combination with secondary reactions within the plasma source, primarily recombination with hydrogen cations (H⁺) to form neutral hydrogen halides (HX).

The present apparatus allows for the direct detection and quantification of atomic halogen anions. A high temperature ionization source such as an inductively coupled plasma (ICP) source is used for generating ions and precursors from a sample. An interface with adjustable pressure is fluidly connected to the ICP-MS source. The interface comprises of a specialized reaction chamber designed to form and contain suitable background ions either from the species generated by the plasma source or through introduction of suitable gases and reagents from a separate path. The reaction chamber can also form and contain hydrogen halide species in high abundance which can then be transferred to a collision/reaction cell. The collision/reaction cell is provided downstream of the interface and reaction chamber, wherein the selectively directed background ions from the reaction chamber undergo controlled ion-molecule or ion-ion reactions with the hydrogen halides extracted from the reaction chamber. A mass analyzer downstream of the collision/reaction cell detects and quantifies atomic halogen anions formed within the cell. The atomic halogen anions can be fluoride (F⁻) and chloride (Cl⁻). Other atoms such as phosphorus, sulfur, bromine, iodine, selenium, and tellurium can also be detected through this method.

Hydrogen halides can be formed upstream in the ICP-MS system and subsequently react within the collision/reaction cell to generate atomic halogen anions. Nitrogen gas is introduced into the high-pressure interface or reaction cell to form background anions selected from the group consisting of NO₂⁻ and NO₃⁻. The background anions NO₂⁻ or NO₃⁻ react with hydrogen halides (HX, where X is a halogen) to produce atomic halogen anions (X⁻).

Embodiment 3 utilizes a standard ICP-MS interface but incorporates a special collision/reaction cell where the formation of atomic halogen anions is facilitated by the external introduction of halogen-containing compounds of interest. (1) Formation of Background Anions in the Interface: Background anions such as O⁻, OH⁻, O₂⁻, or NO₂⁻ are formed within the standard ICP-MS interface itself. (2) Selective Background Ion Selection: A first mass filter (Q1) is used to select a suitable background ion (e.g., O⁻) from those formed in the interface. (3) External Injection of Halogen Compounds: Hydrogen halides (HF or HCl) or other halogen compounds are introduced externally into the collision/reaction cell located within the standard interface. (4) Reaction with Selected Background Ion: Inside the collision/reaction cell, the selected background ion (e.g., O⁻) reacts with the externally introduced halogen compound (e.g., HF or HCl) to produce the atomic halogen anions (F⁻ or Cl⁻). The specific reaction mechanism will depend on the chosen background ion and halogen compound. (5) Second Mass Analysis: The resulting ions, including the atomic halogen anions, are then analyzed by a second mass analyzer for detection and quantification.

Embodiment 3 is a hybrid tandem inductively coupled plasma (ICP) mass spectrometer including a plasma source (501), an interface region (502), an ion optics assembly (503), a first mass filter Q1 (504), a collision/reaction cell (505), a second mass filter Q2 (506), and a detector (507), wherein formation of atomic halogen anions is facilitated by external introduction of halogen-containing compounds. (1) Formation of Background Anions in the Interface: Background anions, including O⁻, OH⁻, O₂⁻, or NO₂⁻, are formed within the interface region (502) downstream of the plasma source (501). (2) Selective Background Ion Selection: A selected background ion is transmitted through the ion optics assembly (503) and is mass-selected by the first mass filter Q1 (504). (3) External Injection of Halogen Compounds: Hydrogen halides (HF or HCl) or other halogen-containing compounds are introduced into the collision/reaction cell (505) via a gas introduction system (508). (4) Reaction with Selected Background Ion: Within the collision/reaction cell (505), the selected background ion (e.g., O⁻) reacts with the introduced halogen-containing compound (e.g., HF or HCl) to form atomic halogen anions (F⁻ or Cl⁻). (5) Second Mass Analysis: The resulting ions are transmitted through the second mass filter Q2 (506) and detected by the detector (507) for analysis and quantification.

1. A method for detecting halogen species in a mass spectrometer, comprising:
a. introducing a sample comprising halogen-containing analytes into a high-temperature ionization source to desolvate, vaporize, atomize, and ionize the sample;
b. directing products from the ionization source into a vacuum chamber having a sampling interface comprising a reaction chamber with adjustable pressure and gas composition;
c. forming halogen-containing compounds or species derived therefrom within the reaction chamber by reaction of species generated by the ionization source and/or by reaction with gases or reagents introduced into the reaction chamber to generate hydrogen halide species;
d. transferring at least a portion of the halogen-containing compounds or species derived therefrom from the reaction chamber to a collision/reaction cell via a transfer line;
e. introducing selected background ions into the collision/reaction cell;
f. reacting the selected background ions with the halogen-containing compounds or species derived therefrom within the collision/reaction cell to generate halogen anions, and
g. detecting the halogen anions using a mass analyzer, thereby enabling quantification of halogen concentration in the sample,
whereby the halogen-containing compounds or species derived therefrom are formed in the reaction chamber and halogen anions are generated in the collision/reaction cell, and thereby, the method improves sensitivity of halogen detection relative to direct detection of ions from the ionization source by converting the halogen-containing compounds or species derived therefrom that would otherwise be undetectable into detectable halogen anions.

2. The method of claim 1, further comprising controlling flow of the halogen-containing compounds or species derived therefrom by adjusting at least one of pressure within the reaction chamber or a valve associated with the transfer line, wherein the reaction chamber is maintained at a pressure higher than a pressure of the collision/reaction cell to facilitate transfer of the halogen-containing compounds or species derived therefrom.

3. The method of claim 1, wherein the reaction chamber generates an increased concentration of neutral hydrogen halides.

4. The method of claim 1, wherein reacting comprises converting the neutral hydrogen halide of the form HX into an atomic halogen anion, X⁻, wherein X is any one of fluorine, chlorine, bromine, or iodine.

5. The method of claim 1, further comprising introducing one or more gases or reagents into the reaction chamber to promote formation of the halogen-containing compounds or species derived therefrom.

6. The method of claim 1, further comprising selecting the background ion using a mass filter prior to introduction into the collision/reaction cell, wherein the reacting comprises an ion-molecule reaction between the background ion and the neutral halogen-containing compound or species derived therefrom.

7. The method of claim 1, further comprising selecting background ions having an electron affinity lower than that of a halogen atom to promote formation of halogen anions, and excluding ions having higher electron affinity.

8. The method of claim 1, wherein the background ion comprises at least one of O⁻, OH, O₂⁻, NO₂⁻, or CO₃²⁻.

9. The method of claim 1, wherein the background ions are generated from species produced in the ionization source and/or from gases or reagents introduced into the reaction chamber.

10. The method of claim 1, further comprising converting neutral hydrogen halides into atomic halogen anions to enhance sensitivity of halogen detection.

11. The method of claim 1, wherein the reaction chamber is external to the mass spectrometer and fluidically coupled thereto.

12. The method of claim 1, wherein the ionization source is separate from the mass spectrometer and fluidically coupled thereto.

13. The method of claim 1, further comprising introducing a collision/reaction gas into at least one of the reaction chamber or the collision/reaction cell to enhance formation of halogen anions.

14. A mass spectrometer system for detecting halogen species, comprising:
a. a high-temperature ionization source configured to receive a sample comprising halogen-containing analytes and to desolvate, vaporize, atomize, and ionize the sample;
b. a vacuum chamber comprising a sampling interface including a reaction chamber having an adjustable pressure and an adjustable gas composition;
c. a gas delivery system fluidically coupled to the reaction chamber to introduce a gas or reagent into the reaction chamber;
d. a transfer line fluidically coupled to the reaction chamber;
e. a collision/reaction cell fluidically coupled to the reaction chamber via the transfer line, having an adjustable gas composition;
f. an ion introduction system configured to introduce selected background ions into the collision/reaction cell, and
g. a mass analyzer downstream of the collision/reaction cell configured to detect halogen anions,
wherein the reaction chamber is configured to form or generate halogen-containing compounds or species derived therefrom and the collision/reaction cell is configured to react the selected background ions with the halogen-containing compounds or species derived therefrom to generate halogen anions.

15. A mass spectrometer system for generating halogen anions, comprising:
a. an ionization source configured to generate ions and neutral species;
b. a collision/reaction cell having an adjustable gas composition;
c. a mass filter configured to select a background ion based on electron affinity relative to a halogen-containing compound or species derived therefrom, and
d. a detector configured to detect halogen anions, wherein the collision/reaction cell is configured to react the selected background ion with the halogen-containing compound or species derived therefrom.

16. The system of claim 14, wherein the reaction chamber is configured to form or generate halogen-containing compounds including neutral hydrogen halides.

17. The system of claim 14, wherein the transfer line is configured to transport the halogen-containing compounds or species derived therefrom from the reaction chamber to the collision/reaction cell.

18. The system of claim 14, further comprising a first mass filter configured to select the background ion prior to introduction into the collision/reaction cell.

19. The system of claim 15, wherein the mass filter is configured to select background ions such that the background ion has an electron affinity lower than that of the halogen atom.

20. The system of claim 14, wherein the ionization source comprises an inductively coupled plasma (ICP) source.

21. The system of claim 14, further comprising a second ion source configured to generate the selected background ions independently of the ionization source and to supply the selected background ions to the collision/reaction cell.
